(19) United States
(12) Patent Application Publication
(10) Pub. No.: US 2023/0367314 A1
(43) Pub. Date: Nov. 16, 2023

(54) AUTOMATIC CONTROL METHOD AND SYSTEM FOR FIXED-WING AIRCRAFT AND AUTONOMOUS DRIVING VEHICLES

(71) Applicant: Mu Tang, Urumqi (CN)

(72) Inventor: Mu Tang, Urumqi (CN)

(21) Appl. No.: 18/361,167

(22) Filed: Jul. 28, 2023

(30) Foreign Application Priority Data
Jun. 14, 2023 (CN) 202310707826.0

(51) Int. Cl. G05D 1/00; G05D 1/08

(52) U.S. Cl. CPC G05D 1/0088; G05D 1/0825

(57) ABSTRACT

The present invention discloses an automatic control method and system for fixed-wing aircraft and autonomous driving vehicles, which pertains to the field of aircraft control technology. The method comprises the following steps: acquire actual measurement data and relevant data measured by a laser gyroscope system during the motion process of the fixed-wing aircraft/autonomous driving vehicles to calculate the force data acting on the aircraft/vehicles; establish a three-dimensional spatial model and construct a force control coordinate model within the three-dimensional spatial model based on the force data acting on the aircraft/vehicles and automatically control the operational state and position of the aircraft/vehicles based on the force control coordinate model. The present invention combines the principles of mechanics to simulate the fundamental logic of driver operation techniques, and combines real-time data to enable precise and effective automatic control of aircraft and vehicles.

### TECHNICAL FIELD

The present invention relates to the field of aircraft control technology, more specifically, to an automatic control method and system for fixed-wing aircraft and autonomous vehicles.

### BACKGROUND

The operation of fixed-wing aircraft and autonomous vehicles should ideally adhere to the principles and logical framework of piloting an aircraft or driving a vehicles. This ensures the maximum utilization of their capabilities and enables the autonomous driving technology to realize its full potential. However, the techniques of human drivers have not been fully developed, formalized, or systematized into a comprehensive theoretical framework. As a result, the transfer of control techniques often relies on experiential teaching methods, while autonomous driving systems lack a complete control logic that can faithfully replicate the driving skills of human drivers. Consequently, achieving the desired level of performance with autonomous driving systems becomes challenging.

### SUMMARY

To overcome the aforementioned challenges, or at least mitigate them to some extent, the present invention provides an automatic control method and system for fixed-wing aircraft and autonomous driving vehicles, which combines the principles of mechanics to simulate the fundamental logic of driver control techniques, and combines real-time data to enable precise and effective automatic control of aircraft and vehicles.

In order to address the aforementioned technical challenges, the present invention employs the following technical solution:

Firstly, the present invention provides an automatic control method for fixed-wing aircraft and autonomous vehicles, which comprise the following steps:

Acquire actual measurement data and relevant data measured by a laser gyroscope system during the motion process of the fixed-wing aircraft/autonomous driving vehicles to calculate the force data acting on the aircraft/vehicles.

Establish a three-dimensional spatial model and construct a force control coordinate model within the three-dimensional spatial model based on the force data acting on the aircraft/vehicles and automatically control the operational state and position of the aircraft/vehicles based on the force control coordinate model.

This method employs principles of mechanics to comprehensively describe the fundamental logic behind driver control techniques and calculate the relevant force data based on actual measurement data from the aircraft/vehicles. Subsequently, through data modeling, the method guides the flight control/car control system to establish an effective automatic control logic that can adapt to various airflow variations. This method is able to effectively harness the potential of autonomous driving, enabling automatic control to be more precise and efficient than that of human drivers.

Based on the first aspect, further to that, the aforementioned force data acting on the aircraft/vehicles includes lateral force data acting on them, vertical force data acting on them, and horizontal force data acting on them.

Based on the first aspect, further to that, the aforementioned method to establish a force control coordinate model within the three-dimensional space model based on the force data acting on aircraft/vehicles includes the following steps:

In the established three-dimensional space model, four interconnected coordinate axes are established based on the force data acting on the aircraft/vehicles. Each coordinate axis represents different force data acting on the aircraft/vehicles, forming a force control coordinate model for controlling the position, velocity, and state of the aircraft/vehicles.

Based on the first aspect, further to that, the aforementioned four interconnected coordinate axes comprise the first coordinate axis, the second coordinate axis, the third coordinate axis, and the fourth coordinate axis, wherein:

The first coordinate axis represents the predetermined position of the aircraft/vehicles, while the second coordinate axis represents the actual operational velocity, altitude, trajectory, and lateral position of the aircraft/vehicles. The third coordinate axis represents the operational state of the aircraft/vehicles, and the fourth coordinate axis represents the forces acting on the aircraft/vehicles in the lateral, vertical, and horizontal axes;

The second coordinate axis is associated with the first coordinate axis based on velocity, the third coordinate axis is associated with the second coordinate axis based on the rate of change of horizontal velocity, and the fourth coordinate axis is associated with the third coordinate axis based on horizontal acceleration.

Secondly, the present invention provides an automatic control system for fixed-wing aircraft and autonomous driving vehicles, which comprises a force calculation module and a modeling control module, wherein:

The force calculation module is applied to acquire actual measurement data and relevant data measured by a laser gyroscope system during the motion process of the fixed-wing aircraft/autonomous driving vehicles to calculate the force data acting on the aircraft/vehicles;

The modeling control module is applied to establish a three-dimensional spatial model and construct a force control coordinate model within the three-dimensional spatial model based on the force data acting on the aircraft/vehicles and automatically control the operational state and position of the aircraft/vehicles based on the force control coordinate model.

Through the collaboration of multiple modules, including the force calculation module and the modeling control module, this system employs principles of mechanics to comprehensively describe the fundamental logic behind driver control techniques and calculate the relevant force data based on actual measurement data from the aircraft/vehicles. Subsequently, through data modeling, the system guides the flight control/car control system to establish an effective automatic control logic that can adapt to various airflow variations. This system is able to effectively harness the potential of autonomous driving, enabling automatic control to be more precise and efficient than that of human drivers.

Thirdly, this application provides an electronic device comprising a memory for storing one or more programs; when the processor executes one or more programs, any one of the methods as claimed in the aforementioned first aspect is achieved.

Fourthly, this application provides a computer-readable storage medium, wherein computer programs are stored thereon, and when said computer programs are executed by a processor, any one of the methods as claimed in the aforementioned first aspect is achieved.

The present invention boasts at least the following several advantages and beneficial effects:

The present invention provides an automatic control method and system for fixed-wing aircraft and autonomous driving vehicles, which employs principles of mechanics to comprehensively describe the fundamental logic behind driver control techniques and calculate the relevant force data based on actual measurement data from the aircraft/vehicles. Subsequently, through data modeling, the method guides the flight control/car control system to establish an effective automatic control logic that can adapt to various airflow variations.

### DRAWING DESCRIPTION

To provide a clearer understanding of the technical solution in the embodiment of the present application, a brief introduction to the drawing used in the embodiment will be provided. It should be understood that the drawing only represents certain embodiments of the present application and should not be considered as limiting the scope thereof. Ordinary skilled persons in the field can also obtain other related drawings based on the drawing without exercising inventive effort.

FIG. 1 is a flowchart of the present embodiment depicting an automatic control method for fixed-wing aircraft and autonomous driving vehicles;

FIG. 2 is a schematic diagram of the present embodiment depicting an automatic control system for fixed-wing aircraft and autonomous driving vehicles;

FIG. 3 is a structural diagram of an electronic device provided by the present embodiment of the present invention.

The reference numbers are: 100. Force Calculation Module; 200. Modeling Control Module; 101. Memory; 102. Processor; 103. Communication Interface.

### DETAILED IMPLEMENTATION METHODS

In order to provide a clear description of the objectives, technical solutions, and advantages of the embodiment of the present invention, the following will combine the drawing of the embodiment of the present invention to describe the technical solutions in a clear and complete manner. It is evident that the described embodiment is only a part of the embodiments of the present invention, not all of them. The components of the embodiment of the present invention described and illustrated in the drawing can be arranged and designed in various configurations.

Therefore, the detailed description of the embodiments of the present invention provided in the drawing is not intended to limit the scope of the present invention, but only represents selected embodiments of the present invention. Based on the embodiments disclosed in the present invention, all other embodiments that ordinary skilled persons can obtain without exercising inventive effort are within the scope of protection of the present invention.

It should be noted that similar reference numbers and letters in the following drawing represent similar items, so once an item is defined in one drawing, it does not need to be further defined or explained in subsequent drawing.

It should be noted that in this document, terms such as “first” and “second” and the like indicating relationships are used solely to distinguish one entity or operation from another, without necessarily implying any actual relationship or sequence between these entities or operations. Moreover, the term “including” or any of its other variations is intended to encompass a non-exclusive inclusion, which means that a process, method, item, or device comprising a series of elements includes not only those explicitly listed elements but also other unlisted elements or elements that are inherently part of such process, method, item, or device. Unless further limited, the use of the phrase “including a . . . ” to define an element does not exclude the presence of additional identical elements in the process, method, item, or device that includes the specified element.

In the description of the embodiment of the present invention, it should be noted that terms such as “center,” “top,” “bottom,” “left,” “right,” “vertical,” “horizontal,” “inner,” “outer,” and the like indicating directions or positional relationships are based on the orientations or positional relationships shown in the drawings or the customary orientations or positional relationships when the inventive product is used. These terms are used for convenience of describing the present invention and simplifying the description, and should not be construed as limiting the devices or components to specific orientations or constructing and operating in specific orientations, and thus should not be understood as limitations of the present invention. Additionally, terms such as “first,” “second,” and “third”, etc., are used for distinguishing purposes in the description and should not be construed as indicating or implying relative importance.

Furthermore, the terms “horizontal,” “vertical,” “perpendicular,” and the like do not imply an absolute requirement for the components to be perfectly horizontal or perpendicular but allow for slight inclination. When we refer to “horizontal,” it merely indicates a direction that is relatively more horizontal compared to “vertical,” and it does not imply that the structure must be perfectly level but can have a slight inclination.

In the description of the embodiment of the present invention, “multiple” represents at least two.

### EMBODIMENT

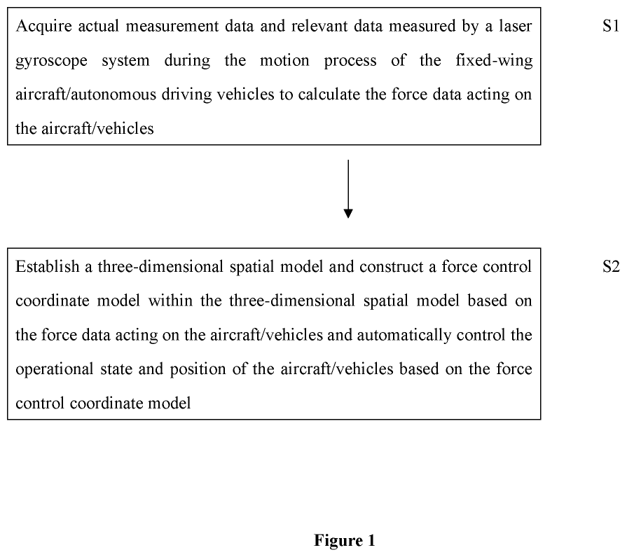

As shown in FIG. 1, firstly, the present invention provides an automatic control method for fixed-wing aircraft and autonomous driving vehicles, which comprise the following steps:

S1, acquire actual measurement data and relevant data measured by a laser gyroscope system during the motion process of the fixed-wing aircraft/autonomous driving vehicles to calculate the force data acting on the aircraft/vehicles; The aforementioned relevant data includes vertical acceleration, horizontal acceleration, lateral acceleration, ground speed, descent rate, track deviation rate, true airspeed, airspeed variation rate, and so on.

S2, establish a three-dimensional spatial model and construct a force control coordinate model within the three-dimensional spatial model based on the force data acting on the aircraft/vehicles and automatically control the operational state and position of the aircraft/vehicles based on the force control coordinate model.

This method employs principles of mechanics to comprehensively describe the fundamental logic behind driver control techniques. The control logic is based on the state of forces, and the specific operational methods employed by the pilot, such as attitude, bank angle, heading, throttle, and rudder, are specific control methods used to achieve control of the force state. In other words, the objective of actual manipulation is to control the aircraft's force state to reach the intended values. Due to the limitations of aircraft performance, variations in attitude, bank angle, and other control surfaces should be constrained within the allowable range of the aircraft's capabilities. If it becomes necessary to exceed this range, a degraded mode should be entered, for example, by trading altitude for airspeed or vice versa, or recalculating a new expected aircraft position to plan a new trajectory. In the event of significant force variations, such as wind shear, where neither altitude nor airspeed provide sufficient margins, an alternate logic should be employed, such as go-around or maximum throttle, to rapidly exit the wind shear region. Regardless of the logic that needs to be applied, it must be based on the force state, which is the foundation of this invention's force control coordinate model. Calculate the relevant force data based on actual measurement data from the aircraft. Subsequently, through data modeling, the method guides the flight control/car control system to establish an effective automatic control logic that can adapt to various airflow variations. This method is able to effectively harness the potential of autonomous driving, enabling automatic control to be more precise and efficient than that of human drivers.

The aforementioned principle for calculating forces involves determining the variations in forces along the lateral, vertical, and longitudinal axes of the aircraft/vehicles by combining the relevant data obtained from the laser gyroscope system with the actual measurements taken during the motion process of the aircraft/autonomous driving vehicles.

The control principle of the present invention comprises establishing a system with four interconnected coordinate axes within a three-dimensional space. The first coordinate axis represents the desired position of the aircraft/vehicles, namely the planned flight trajectory and the expected values for speed, altitude, heading, lateral position, etc. The second coordinate axis represents the actual speed, altitude, heading, lateral position of the aircraft/vehicles, with speed serving as the link between the first and second axes. It also displays parameters such as heading, climb/descent rate, and lateral position deviation. The third coordinate axis represents the state of the aircraft/vehicles, including attitude, pitch, throttle, rudder, and heading. It is connected to the second axis through the rate of change of horizontal speed, and comprises the elements of actual pilot control actions. The fourth coordinate axis represents the forces acting on the aircraft/vehicles along its three axes, namely horizontal fore-aft, horizontal lateral, and vertical longitudinal. It is linked to the third axis through horizontal acceleration.

Due to the fact that airflow affects the aircraft/vehicle in the form of forces, so the fourth coordinate axis reflects the actual variations in wind force, while the control system only needs to manipulate the control surfaces that correspond to the pilot's actions. By adjusting the aircraft/vehicles' attitude, throttle, pitch, and rudder, the four coordinate axes can be maintained within a certain range of stability. This enables effective control of the aircraft/car to adapt to various airflow variations, including wind shears. In theory, by precisely controlling the force state, the control accuracy of the control surfaces can be refined beyond human capability. This allows for precise control in any position and state, such as automatic control during special flight conditions or achieving precise positioning and landing within a specified range.

Based on the first aspect, further to that, the aforementioned force data acting on the aircraft/vehicles includes lateral force data acting on them, vertical force data acting on them, and horizontal force data acting on them.

Based on the first aspect, further to that, the aforementioned method to establish a force control coordinate model within the three-dimensional space model based on the force data acting on aircraft/vehicles includes the following steps:

In the established three-dimensional space model, four interconnected coordinate axes are established based on the force data acting on the aircraft/vehicles. Each coordinate axis represents different force data acting on the aircraft/vehicles, forming a force control coordinate model for controlling the position, velocity, and state of the aircraft/vehicles.

Based on the first aspect, further to that, the aforementioned four interconnected coordinate axes comprise the first coordinate axis, the second coordinate axis, the third coordinate axis, and the fourth coordinate axis, wherein:

The first coordinate axis represents the predetermined position of the aircraft/vehicles, while the second coordinate axis represents the actual operational velocity, altitude, trajectory, and lateral position of the aircraft/vehicles. The third coordinate axis represents the operational state of the aircraft/vehicles, and the fourth coordinate axis represents the forces acting on the aircraft/vehicles in the lateral, vertical, and horizontal axes;

The second coordinate axis is associated with the first coordinate axis based on velocity, the third coordinate axis is associated with the second coordinate axis based on the rate of change of horizontal velocity, and the fourth coordinate axis is associated with the third coordinate axis based on horizontal acceleration.

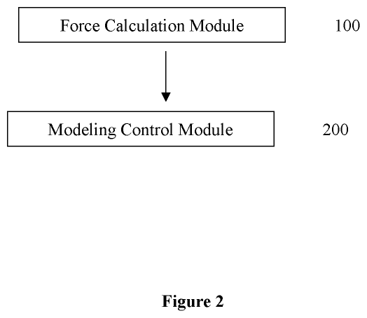

As shown in FIG. 2, secondly, the present invention provides an automatic control method for fixed-wing aircraft and autonomous driving vehicles, which comprises a force calculation module 100 and a modeling control module 200, wherein:

The force calculation module 100 is applied to acquire actual measurement data and relevant data measured by a laser gyroscope system during the motion process of the fixed-wing aircraft/autonomous driving vehicles to calculate the force data acting on the aircraft/vehicles;

The modeling control module 200 is applied to establish a three-dimensional spatial model and construct a force control coordinate model within the three-dimensional spatial model based on the force data acting on the aircraft/vehicles and automatically control the operational state and position of the aircraft/vehicles based on the force control coordinate model.

Through the collaboration of multiple modules, including the force calculation module 100 and the modeling control module 200, this system employs principles of mechanics to comprehensively describe the fundamental logic behind driver control techniques and calculate the relevant force data based on actual measurement data from the aircraft/vehicles. Subsequently, through data modeling, the system guides the flight control/car control system to establish an effective automatic control logic that can adapt to various airflow variations. This system is able to effectively harness the potential of autonomous driving, enabling automatic control to be more precise and efficient than that of human drivers.

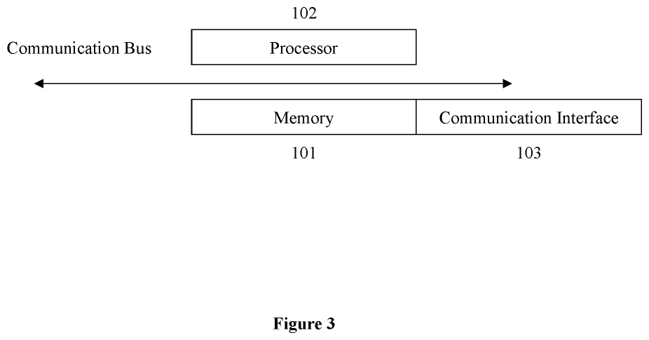

As shown in FIG. 3, thirdly, the embodiment of the present application provides an electronic device comprising a memory 101 for storing one or more programs and processor 102. When the processor 102 executes one or more programs, any one of the methods as claimed in the aforementioned first aspect is achieved.

A communication interface 103 is also included. The memory 101, the processor 102, and the communication interface 103 are directly or indirectly electrically interconnected to facilitate data transmission or interaction. For instance, these components can be electrically connected to each other through one or multiple communication buses or signal lines. The memory 101 is used for storing software programs and modules, while the processor 102 executes the software programs and modules stored in the memory 101, enabling various functional applications and data processing. The communication interface 103 can be applied to facilitate communication of signals or data with other nodal devices.

The memory 101 can be, but not limited to, various types of memories including Random Access Memory (RAM), Read-Only Memory (ROM), Programmable Read-Only Memory (PROM), Erasable Programmable Read-Only Memory (EPROM), Electrically Erasable Programmable Read-Only Memory (EEPROM), and others.

The processor 102 can be an integrated circuit chip with signal processing capabilities. It can be a general-purpose processor, such as a Central Processing Unit (CPU) or a Network Processor (NP). Alternatively, it can be a Digital Signal Processor (DSP), an Application Specific Integrated Circuit (ASIC), a Field-Programmable Gate Array (FPGA), or other programmable logic devices, discrete gates, transistor logic devices, or discrete hardware components.

In the embodiments provided in the present application, it should be understood that the disclosed methods and systems can also be achieved in alternative ways. The described embodiments of methods and systems are provided for illustrative purposes only. For example, the flowcharts and block diagrams in the figures depict possible architectures, functionalities, and operations of the methods, systems, and computer program products according to various embodiments of the present application. Each block in the flowcharts or block diagrams can represent a module, a program segment, or a portion of code, which includes one or more executable instructions for implementing the specified logical functions. It should also be noted that in some alternative implementations, the functions indicated in the blocks may occur in a different order than what is depicted in the figures. For instance, two consecutive blocks may be executed substantially in parallel, or they may be performed in reverse order, depending on the functionality involved. Furthermore, it is important to note that each block in the block diagrams and/or flowcharts, as well as combinations of blocks in the block diagrams and/or flowcharts, can be implemented using specialized hardware systems that perform the specified functions or actions, or they can be implemented using a combination of dedicated hardware and computer instructions.

Furthermore, in various embodiments of the present application, the functional modules can be integrated together to form a cohesive unit, or they can exist as individual modules. Additionally, two or more modules can be combined to form an independent unit.

Fourthly, the embodiments of the present application provide a computer-readable storage medium storing a computer program that, and when it is executed by the processor 102, any one of the methods as claimed in the aforementioned first aspect is achieved. If the functionalities are implemented and sold or used as independent products in the form of software functional modules, they can be stored in a computer-readable storage medium. Based on this understanding, the essential part or the contributing part to the existing technology of the present embodiments can be embodied in the form of a software product stored in a storage medium. The computer software product comprises a plurality of instructions for causing a computer device (which can be a personal computer, server, or network device, etc.) to perform all or part of the steps of the methods described in the embodiments of the present application. The aforementioned storage medium includes various media capable of storing program code, such as USB flash drives, external hard drives, Read-Only Memory (ROM), Random Access Memory (RAM), magnetic disks, or optical discs.

The aforementioned are merely preferred embodiments of the present invention and should not be construed as limiting the scope of the present invention. For those skilled persons in this field, the present invention may subject to various modifications and changes. Any modifications, equivalent substitutions, improvements, etc., made within the spirit and principles of the present invention should be included within the scope of protection of the present invention.

For those skilled persons in this field, it is evident that the present application is not limited to the details of the exemplary embodiments described above. Furthermore, the present application can be implemented in various specific forms without departing from the spirit or essential characteristics of the invention. Therefore, the embodiments should be considered as illustrative and non-restrictive from any perspective, and the scope of the present application is defined by the appended claims rather than the foregoing description. Accordingly, all variations that fall within the meaning and scope of the equivalent elements of the claims are intended to be encompassed within the present application. Any reference signs in the claims should not be construed as limiting the scope of the claims involved.

What is claimed is:

1. An automatic control method for fixed-wing aircraft and autonomous driving vehicles, characterized by comprising the following steps
Acquire actual measurement data and relevant data measured by a laser gyroscope system during the motion process of the fixed-wing aircraft/autonomous driving vehicles to calculate the force data acting on the aircraft/vehicles;
Establish a three-dimensional spatial model and construct a force control coordinate model within the three-dimensional spatial model based on the force data acting on the aircraft/vehicles and automatically control the operational state and position of the aircraft/vehicles based on the force control coordinate model.

2. An automatic control method and system for fixed-wing aircraft and autonomous driving vehicles according to claim 1, characterized in that: The aforementioned force data acting on the aircraft/vehicles includes lateral force data acting on them, vertical force data acting on them, and horizontal force data acting on them.

3. An automatic control method and system for fixed-wing aircraft and autonomous driving vehicles according to claim 2, characterized in that: The method to establish a force control coordinate model within the three-dimensional space model based on the force data acting on aircraft/vehicles includes the following steps:
In the established three-dimensional space model, four interconnected coordinate axes are established based on the force data acting on the aircraft/vehicles. Each coordinate axis represents different force data acting on the aircraft/vehicles, forming a force control coordinate model for controlling the position, velocity, and state of the aircraft/vehicles.

4. An automatic control method and system for fixed-wing aircraft and autonomous driving vehicles according to claim 3, characterized in that: The aforementioned four interconnected coordinate axes comprise the first coordinate axis, the second coordinate axis, the third coordinate axis, and the fourth coordinate axis, wherein:
The first coordinate axis represents the predetermined position of the aircraft/vehicles, while the second coordinate axis represents the actual operational velocity, altitude, trajectory, and lateral position of the aircraft/vehicles. The third coordinate axis represents the operational state of the aircraft/vehicles, and the fourth coordinate axis represents the forces acting on the aircraft/vehicles in the lateral, vertical, and horizontal axes;
The second coordinate axis is associated with the first coordinate axis based on velocity, the third coordinate axis is associated with the second coordinate axis based on the rate of change of horizontal velocity, and the fourth coordinate axis is associated with the third coordinate axis based on horizontal acceleration.

5. An automatic control method and system for fixed-wing aircraft and autonomous driving vehicles, characterized in that: It comprises a force calculation module and a modeling control module, wherein:
The force calculation module is applied to acquire actual measurement data and relevant data measured by a laser gyroscope system during the motion process of the fixed-wing aircraft/autonomous driving vehicles to calculate the force data acting on the aircraft/vehicles;
The modeling control module is applied to establish a three-dimensional spatial model and construct a force control coordinate model within the three-dimensional spatial model based on the force data acting on the aircraft/vehicles and automatically control the operational state and position of the aircraft/vehicles based on the force control coordinate model.

6. An electronic device, characterized in that: it comprises:
A memory for storing one or more programs;
A processor;
When the processor executes one or more programs, any one of the methods as claimed in claim 1 is achieved.

7. A computer-readable storage medium, wherein computer programs are stored thereon, characterized in that: When said computer programs are executed by a processor, any one of the methods as claimed in claim 1 is achieved.
